(19) United States
(12) Patent Application Publication
(10) Pub. No.: US 2023/0206158 A1
(43) Pub. Date: Jun. 29, 2023

(54) METHOD AND APPARATUS FOR GENERATING A CUMULATIVE PERFORMANCE SCORE FOR A SALESPERSON

(71) Applicant: Uniphore Technologies, Inc., Palo Alto, CA (US)

(72) Inventors: Saurabh Saxena, San Jose, CA (US); Mario Gomez, Valencia (ES); Alejandro Lavale, Valencia (ES)

(21) Appl. No.: 18/116,288

(22) Filed: Mar. 1, 2023

Related U.S. Application Data
(63) Continuation of application No. PCT/US2022/053909, filed on Dec. 23, 2022.
(60) Provisional application No. 63/315,526, filed on Mar. 1, 2022.
(60) Provisional application No. 63/293,659, filed on Dec. 23, 2021.

(51) Int. Cl. G06Q 10/0639

(52) U.S. Cl. CPC G06Q 10/06393

(57) ABSTRACT

An apparatus for generating a cumulative performance score for a salesperson, and a memory storing instructions that, when executed by the processor, configure the apparatus to perform a method. The method includes receiving audio data for at least the sal esperson from a first event having multiple participants including a salesperson, extracting one or more of tonal information or text information from the audio data for the salesperson, and extracting therefrom, behavioral parameters for the salesperson for one or more time intervals during the first event. The behavioral parameters include two or more of empathy, stress, politeness, or hesitation. The method further includes determining a first performance score for the salesperson based on the behavioral parameters, and sending the first performance score for display.

### CROSS-REFERENCE TO RELATED APPLICATIONS

This application claims priority to the International Patent Application No. PCT/US2022/053909 filed on 23 Dec. 2022, which claims priority to the U.S. Provisional Patent Application Ser. No. 63/293,659, filed on 23 Dec. 2021, and U.S. Provisional Patent Application Ser. No. 63/315,526, filed on 1 Mar. 2022, each of which is incorporated by reference herein.

### FIELD

The present invention relates generally to video and audio processing, and specifically to generating a cumulative performance score for a salesperson.

### BACKGROUND

Several business and non-business meetings are now conducted in a multimedia mode, for example, web-based audio and video conferences including multiple participants. Reviewing such multimedia meetings, in which significant amount of data, different modes of data is shared and presented, to identify key information therefrom has proven to be cumbersome and impractical. While there exists a wealth of information regarding various participants in such meetings, it has been difficult to extract meaningful information from such meetings.

Accordingly, there exists a need in the art for techniques for generating a cumulative performance score for a salesperson.

### SUMMARY

The present invention provides a method and an apparatus for generating a cumulative performance score for a salesperson, substantially as shown in and/or described in connection with at least one of the figures, as set forth more completely in the claims. These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

So that the manner in which the above-recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates an apparatus for generating a cumulative performance score for a salesperson, according to one or more embodiments.

FIG. 2 illustrates the analytics server of FIG. 1, according to one or more embodiments.

FIG. 3 illustrates a method for identifying key information in a multi-party multimedia communication, according to one or more embodiments.

### DETAILED DESCRIPTION

Embodiments of the present invention relate to a method and an apparatus for generating a cumulative performance score for a salesperson, for example, from several audio or multimedia sales calls (or meetings or events) between the salesperson and potential or actual customers. During a sales call, for example, with one or more customers or participants, interactions of a salesperson, for example, audio data of the salesperson, and optionally video data of the salesperson if the interaction is a multimedia call, are captured. Tonal and text information are extracted from audio data, while vision information is extracted from video data. Behavioral parameters, such as empathy, stress, politeness, hesitation, talk speed, or talk ratio, among others are extracted from one or more of the tonal, text or vision information, and the behavioral parameters are used to determine a performance score for the salesperson for the sales call. Performance scores determined over several such sales calls of the salesperson with same or different customers or potential customers are combined to compute a cumulative performance score (CPS) for the salesperson.

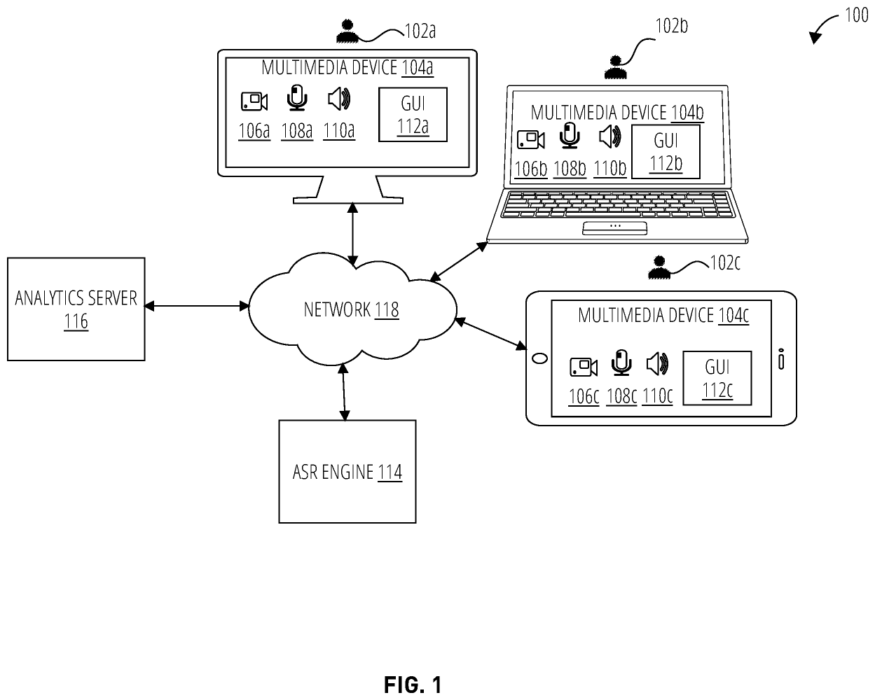

FIG. 1 is a schematic representation of an apparatus 100 for generating a cumulative performance score for a salesperson, according to one or more embodiments of the invention. FIG. 1 shows a participant 102a of a business, such as the salesperson, in a meeting or an event with the business' customers, for example, the participants 102b and 102c (together referred to by the numeral 102), using components of the apparatus 100. The apparatus 100 includes all components shown in FIG. 1, and do not include the participants themselves. Each participant 102, and in particular the salesperson 102a, is associated with a telephonic device or a multimedia device 104a, 104b, 104c (together referred to as devices, and/or by the numeral 104) via which each participant communicates with others in the multi-party communication or a meeting. For example, such meetings are enabled over voice by using regular telephony or VoIP techniques, over multimedia by video calls such as those enabled by ZOOM VIDEO COMMUNICATIONS, INC. of San Jose, Calif., MICROSOFT CORPORATION of Redmond, WA, WEBEX by CISCO Systems of Milpitas, Calif., among several other similar web-based or other multimedia/videoconferencing providers. Each of the devices 104a, 104b, 104c is a computing device, such as a laptop, personal computer, tablet, smartphone, a telephone or a similar device that includes or is operably coupled to, respectively, a microphone 108a, 108b, 108c, and a speaker 110a, 110b, 110c. In some embodiments, the each of the devices also includes or is connected to a camera 106a, 106b, 106c, and/or a graphical user interface (GUI) 112a, 112b, 112c, respectively. The apparatus 100 also includes an automatic speech recognition (ASR) engine 114, and an analytics server 116. Various elements of the apparatus 100 are communicably coupled via a network 118, or via other communication links as known in the art.

The ASR engine 114 is configured to convert speech from the audio of the meeting to text, and can be a commercially available engine or proprietary ASR engines. In some embodiments, the ASR engine 114 is implemented on the analytics server 116.

The analytics server 116 is configured to receive data, for example, audio data and optionally video data from at least the salesperson, for example, from the device 104a used by the sales person to participate in the event.

The network 118 is a communication Network, such as any of the several communication Networks known in the art, and for example a packet data switching Network such as the Internet, a proprietary Network, a wireless GSM Network, among others.

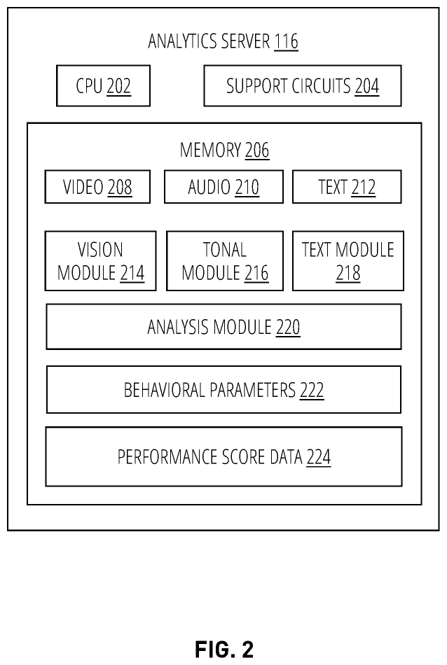

FIG. 2 is a schematic representation of the analytics server 116 of FIG. 1, according to one or more embodiments. The analytics server 116 includes a CPU 202 communicatively coupled to support circuits 204 and a memory 206. The CPU 202 may be any commercially available processor, microprocessor, microcontroller, and the like. The support circuits 204 comprise well-known circuits that provide functionality to the CPU 202, such as, a user interface, clock circuits, network communications, cache, power supplies, I/O circuits, and the like. The memory 206 is any form of digital storage used for storing data and executable software. Such memory includes, but is not limited to, random access memory, read only memory, disk storage, optical storage, and the like. The memory 206 includes computer readable instructions corresponding to an operating system (OS) (not shown), video 208, audio 210 and text 212 corresponding to the meeting. In some embodiments, the text 212 is extracted from the audio 210, for example, by the ASR engine 114. The video 208, the audio 210 and the text 212 (e.g., from ASR engine 114) is available as input, either in real-time or in a passive mode.

The memory 206 further includes a vision module 214, a tonal module 216, a text module 218, an analysis module 220, behavioral parameters 222 and performance score data 224. Each of the modules 214, 216 and 218 extract respective characteristics from video 208, audio 210 and text 212, which characteristics are analyzed by the analysis module 220 to generate behavioral parameters 222, for example, for the salesperson, and other participants of the meeting. In some embodiments, the analysis module 220 utilizes the behavioral data of the salesperson from each sales call or event to determine a performance score of the salesperson for that event. Performance scores of the salesperson are determined for multiple sales calls over time, and may be stored as performance score data 224. In some embodiments, the analysis module 220 combines two or more performance scores of the salesperson to computes a cumulative performance score (CPS), which may also be stored as performance score data 224. In some embodiments, the analysis module 220 computes the CPS based on recent sales calls, for example, past few months or past few deals. In some embodiments, performance scores and CPS for multiple salespersons may be stored in the performance score data 224, and be identified using a unique identifier associated with each of the multiple salespersons.

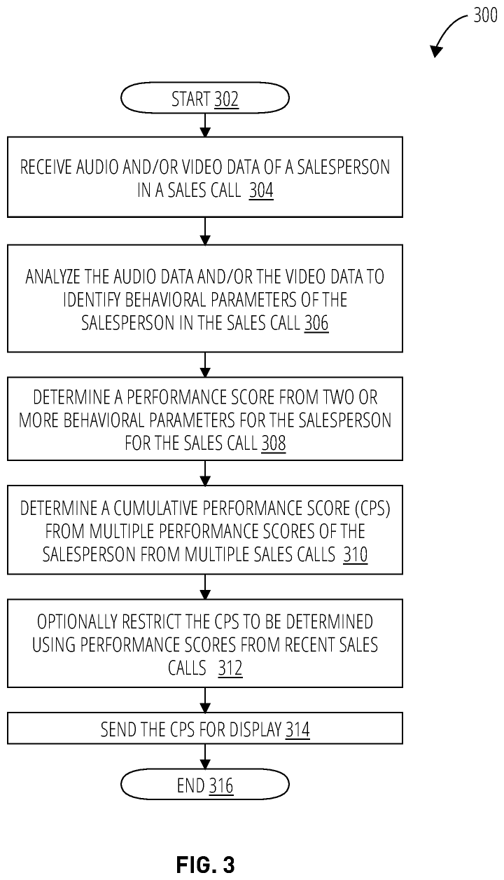

FIG. 3 illustrates a method for identifying key information in a multimedia communication, according to one or more embodiments. In some embodiments, the method 300 is performed by the analysis module 220 of FIG. 2. Although the example method 300 depicts a particular sequence of operations, the sequence may be altered without departing from the scope of the present disclosure. For example, some of the operations depicted may be performed in parallel or in a different sequence that does not materially affect the function of the method 300. In other examples, different components of an example device or system that implements the method 300 may perform functions at substantially the same time or in a specific sequence.

The method 300 starts at step 302, and proceeds to step 304, at which the method 300 receives audio and/or video data of a salesperson in a first event, for example, a sales call having multiple participants including the salesperson. Other people in the sales call may include, for example, customers, potential customers, among others.

The method 300 proceeds to step 306, at which the method 300 analyzes the audio data and/or the video data to identify behavioral parameters for the salesperson in the sales call. Behavioral parameters include, without limitation, one or more of whether the salesperson repeated and confirmed customer's utterances, whether key phrases were mentioned by the salesperson, whether the words used by the salesperson were positive-sentiment words, whether the salesperson spoke with respect, among others. Such and additional parameters extracted from the tonal and text information may also be defined to determine a measure of empathy, stress, politeness, hesitation, talk speed, or talk ratio, among others.

At step 308, the method 300 determines a performance score for the salesperson for the sales call, from two or more behavioral parameters extracted from the tonal and/or text information. For example, the score is computed by rating the performance of the salesperson on a scale of 1-10 for each parameter, and then aggregating the score on each parameter, by way of averaging or weighted averaging.

In some embodiments, behavioral parameters also include facial expression information including a frown, a smile, a head nod, a head tilt, a blink, drowsiness, or looking away extracted from the video data. In such embodiments, the method 300 additionally determines the performance score from one or more additional behavioral parameters extracted from the vision information.

At step 310, the method 300 determines a cumulative performance score (CPS) from multiple performance scores of the salesperson from multiple sales calls, for example, using the methodology of steps 304-308.

In some embodiments, for example, as shown at step 312, the method 300 restricts the CPS determination based on a recent sales calls, for example, for a predefined time (e.g., past 6 months), or other predefined parameters (e.g., past 4 deals). In effect, the method 300 updates the CPS for the salesperson by removing past data outside a predefined parameter (time, number of deals and the like), so that the CPS reflects a recent measure of the salesperson's performance.

At step 314, the method 300 sends one or more of the performance score(s) or the CPS, for example, for display to a device accessible to the salesperson, or to others authorized to view the performance score(s) or the CPS for the salesperson. In some embodiments, the performance score(s) and/or the CPS are sent to a repository for storage along with a unique identifier for the salesperson, for later retrieval and display.

The method 300 proceeds to step 316, at which the method 300 ends.

While the embodiments discussed herein have been described with respect to the salesperson, the techniques described herein may be applied to other participants of the meetings or sales calls, and also in other contexts. Although various methods discussed herein depict a particular sequence of operations, the sequence may be altered without departing from the scope of the present disclosure, unless otherwise apparent from the context. For example, some of the operations depicted may be performed in parallel or in a different sequence that does not materially affect the function of the methods discussed herein. In other examples, different components of an example device or apparatus that implements the methods may perform functions at substantially the same time or in a specific sequence.

The methods described herein may be implemented in software, hardware, or a combination thereof, in different embodiments. In addition, the order of steps in methods can be changed, and various elements may be added, reordered, combined, omitted or otherwise modified. All examples described herein are presented in a non-limiting manner. Various modifications and changes can be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances can be provided for components described herein as a single instance. Boundaries between various components, operations and data stores are somewhat arbitrary, and particular operations are illustrated in the context of specific illustrative configurations. Other allocations of functionality are envisioned and can fall within the scope of claims that follow. Structures and functionality presented as discrete components in the example configurations can be implemented as a combined structure or component. These and other variations, modifications, additions, and improvements can fall within the scope of embodiments as defined in the claims that follow.

In the foregoing description, numerous specific details, examples, and scenarios are set forth in order to provide a more thorough understanding of the present disclosure. It will be appreciated, however, that embodiments of the disclosure can be practiced without such specific details. Further, such examples and scenarios are provided for illustration, and are not intended to limit the disclosure in any way. Those of ordinary skill in the art, with the included descriptions, should be able to implement appropriate functionality without undue experimentation.

References in the specification to “an embodiment,” etc., indicate that the embodiment described can include a particular feature, structure, or characteristic, but every embodiment may not necessarily include the particular feature, structure, or characteristic. Such phrases are not necessarily referring to the same embodiment. Further, when a particular feature, structure, or characteristic is described in connection with an embodiment, it is believed to be within the knowledge of one skilled in the art to affect such feature, structure, or characteristic in connection with other embodiments whether or not explicitly indicated.

Embodiments in accordance with the disclosure can be implemented in hardware, firmware, software, or any combination thereof. Embodiments can also be implemented as instructions stored using one or more machine-readable media, which may be read and executed by one or more processors. A machine-readable medium can include any mechanism for storing or transmitting information in a form readable by a machine (e.g., a computing platform or a “virtual machine” running on one or more computing platforms). For example, a machine-readable medium can include any suitable form of volatile or non-volatile memory.

In addition, the various operations, processes, and methods disclosed herein can be embodied in a machine-readable medium and/or a machine accessible medium/storage device compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium/storage device.

Modules, data structures, and the like defined herein are defined as such for ease of discussion and are not intended to imply that any specific implementation details are required. For example, any of the described modules and/or data structures can be combined or divided into sub-modules, sub-processes or other units of computer code or data as can be required by a particular design or implementation.

In the drawings, specific arrangements or orderings of schematic elements can be shown for ease of description. However, the specific ordering or arrangement of such elements is not meant to imply that a particular order or sequence of processing, or separation of processes, is required in all embodiments. In general, schematic elements used to represent instruction blocks or modules can be implemented using any suitable form of machine-readable instruction, and each such instruction can be implemented using any suitable programming language, library, application-programming interface (API), and/or other software development tools or frameworks. Similarly, schematic elements used to represent data or information can be implemented using any suitable electronic arrangement or data structure. Further, some connections, relationships or associations between elements can be simplified or not shown in the drawings so as not to obscure the disclosure.

This disclosure is to be considered as exemplary and not restrictive in character, and all changes and modifications that come within the guidelines of the disclosure are desired to be protected. Other technical features may be readily apparent to one skilled in the art from the following figures, descriptions, and claims.

While the foregoing is directed to embodiments of the present invention, other and further embodiments of the invention may be devised without departing from the basic scope thereof.

I/we claim:

1. A computer implemented method for generating a cumulative performance score for a salesperson, the method comprising:
receiving, at an analytics server, for a first event having a first plurality of participants comprising a salesperson, audio data for at least the salesperson;
extracting, for the salesperson, at least one of tonal information or text information from the audio data;
extracting, from the at least one of the tonal information or the text information, behavioral parameters for the salesperson for a plurality of time intervals during the first event, wherein the behavioral parameters comprise at least two of empathy, stress, politeness, or hesitation;
determining, based on the behavioral parameters, a first performance score for the salesperson; and
sending the first performance score for display.

2. The computer implemented method of claim 1, wherein empathy, stress, politeness and hesitation is extracted from at least the tonal information.

3. The computer implemented method of claim 1, wherein the behavioral parameters additionally comprise talk speed of the salesperson, or talk ratio of the salesperson with respect to one or more of the plurality of first participants.

4. The computer implemented method of claim 1, further comprising:
receiving video data for the salesperson;
extracting vision information from the video data;
extracting, from the vision information, behavioral parameters comprising at least one of a frown, a smile, a head nod, a head tilt, a blink, drowsiness, or looking away; and
determining, based on the behavioral parameters extracted from the at least one of tonal information, text information or vision information, the first performance score.

5. The computer implemented method of claim1, further comprising determining a second performance score for the salesperson for a second event comprising a second plurality of participants comprising the salesperson.

6. The computer implemented method of claim 5, further comprising combining the first performance score and the second performance score to generate a cumulative performance score (CPS) for the salesperson.

7. The computer implemented method of claim 1, wherein the plurality of time intervals comprise the entire first event.

8. A computing apparatus comprising:
a processor; and
a memory storing instructions that, when executed by the processor, configure the apparatus to:
receive, at an analytics server, for a first event having a first plurality of participants comprising a salesperson, audio data for at least the salesperson;
extract, for the salesperson, at least one of tonal information or text information from the audio data;
extract, from the at least one of the tonal information or the text information, behavioral parameters for the salesperson for a plurality of time intervals during the first event, wherein the behavioral parameters comprise at least two of empathy, stress, politeness, or hesitation;
determine, based on the behavioral parameters, a first performance score for the salesperson; and
send the first performance score for display.

9. The computing apparatus of claim 8, wherein empathy, stress, politeness and hesitation is extracted from at least the tonal information.

10. The computing apparatus of claim 8, wherein the behavioral parameters additionally comprise talk speed of the salesperson, or talk ratio of the salesperson with respect to one or more of the plurality of first participants.

11. The computing apparatus of claim 8, wherein the instructions further configure the apparatus to:
receive video data for the salesperson;
extract vision information from the video data;
extract, from the vision information, behavioral parameters comprising at least one of a frown, a smile, a head nod, a head tilt, a blink, drowsiness, or looking away; and
determine, based on the behavioral parameters extracted from the at least one of tonal information, text information or vision information, the first performance score.

12. A computing apparatus of claim 8, wherein the instructions further configure the apparatus to to determine a second performance score for the salesperson for a second event comprising a second plurality of participants comprising the salesperson.

13. The computing apparatus of claim 12, wherein the instructions further configure the apparatus to combine the first performance score and the second performance score to generate a cumulative performance score (CPS) for the salesperson.

14. The computing apparatus of claim 8, wherein the plurality of time intervals comprise the entire first event.

15. A non-transitory computer-readable storage medium, the computer-readable storage medium including instructions that when executed by a computer, cause the computer to:
receive, at an analytics server, for a first event having a first plurality of participants comprising a salesperson, audio data for at least the salesperson;
extract, for the salesperson, at least one of tonal information or text information from the audio data;
extract, from the at least one of the tonal information or the text information, behavioral parameters for the salesperson for a plurality of time intervals during the first event, wherein the behavioral parameters comprise at least two of empathy, stress, politeness, or hesitation;
determine, based on the behavioral parameters, a first performance score for the salesperson; and
send the first performance score for display.

16. The computer-readable storage medium of claim 15, wherein empathy, stress, politeness and hesitation is extracted from at least the tonal information.

17. The computer-readable storage medium of claim 15, wherein the behavioral parameters additionally comprise talk speed of the salesperson, or talk ratio of the salesperson with respect to one or more of the plurality of first participants.

18. The computer-readable storage medium of claim 15, wherein the instructions further cause the computer to:
receive video data for the salesperson;
extract vision information from the video data;
extract, from the vision information, behavioral parameters comprising at least one of a frown, a smile, a head nod, a head tilt, a blink, drowsiness, or looking away; and
determine, based on the behavioral parameters extracted from the at least one of tonal information, text information or vision information, the first performance score.

19. A non-transitory computer-readable storage medium, the computer-readable storage medium including instructions that when executed by a computer, cause the computer to the salesperson.

20. The computer-readable storage medium of claim 19, wherein the instructions further configure the computer to combine the first performance score and the second performance score to generate a cumulative performance score (CPS) for the salesperson.
